(19) United States
(12) Patent Application Publication
(10) Pub. No.: US 2025/0178300 A1
(43) Pub. Date: Jun. 5, 2025

(54) SERVICER, ASSEMBLY AND METHOD FOR SUPPLYING A TIRE COMPONENT TO A TIRE BUILDING DRUM

(71) Applicant: VMI HOLLAND B.V., Epe (NL)

(72) Inventors: Mattheus Jacobus KAAGMAN, Epe (NL); Ruben Matthias VISSER, Epe (NL)

(21) Appl. No.: 18/844,252

(22) PCT Filed: Feb. 22, 2023
(86) PCT No.: PCT/NL2023/050087

§ 371 Date: Sep. 5, 2024

(30) Foreign Application Priority Data
Mar. 9, 2022 (NL) 2031213

(51) Int. Cl. B29D 30/30; B29D 30/00; B29D 30/28

(52) U.S. Cl. CPC B29D 30/30; B29D 30/0016; B29D 30/28; B29D 2030/0038; B29D 2030/3078

(57) ABSTRACT

A servicer and method are provided for supplying a tire component to a tire building drum or a transfer wheel. The servicer comprises a conveyor for supporting the tire component and a cutter for cutting through the tire component. The cutter comprises a blade extending in a blade plane. The blade plane extends at a blade angle with respect to the conveyor plane about a blade axis parallel to the conveyor plane and transverse to the transport direction. The blade is movable with respect to the conveyor plane in a cutting direction in a cutting plane. The cutting plane extends at an oblique cutting angle with respect to the conveyor plane about an axis parallel to the conveyor plane and transverse to the transport direction, wherein the cutting angle is smaller than the blade angle.

### BACKGROUND

The invention relates to a servicer, an applicator roller, an assembly and a method for supplying a tire component to a tire building drum or a transfer wheel.

A known servicer comprises a conveyor for conveying a continuous elastomeric strip to a tire building drum. The servicer further comprises a cutter bar between said conveyor and the tire building drum and a blade to cut the continuous elastomeric strip to length at said cutter bar. The blade is arranged at an oblique angle with respect to the cutter bar to obtain obliquely cut leading and trailing ends at the cut to length tire component, for reliable splicing. The servicer further comprises a clamping member for clamping the elastomeric strip near the cutting line during cutting.

### SUMMARY OF THE INVENTION

A disadvantage of the known servicer is that the angle of the blade with respect to the conveyor is limited. In particular, a clearance space between the blade and the conveyor is required to accommodate the clamping member and/or one or more drives associated with said clamping member. Said limited angle of the blade causes the leading and trailing ends of the tire components to be cut at an obtuse angle. Said obtuse leading and trailing ends can negatively influence the quality of a splice between said leading end and trailing end, which may ultimately lead to a reduced quality of the resulting tire.

It is an object of the present invention to provide a servicer, and a method for supplying a tire component to a tire building drum or a transfer wheel, wherein the quality of the resulting tire can be improved.

It is a further object of the present invention to provide an assembly for supplying a tire component to a tire building drum, wherein the tire component can be applied or assembled more effectively on said tire building drum.

According to a first aspect, the invention provides a servicer for supplying a tire component to a tire building drum or a transfer wheel, wherein the servicer comprises a conveyor for supporting the tire component at a first side of a conveyor plane and for transporting said tire component in a transport direction parallel to said conveyor plane, wherein the servicer further comprises a cutter for cutting through the tire component along a cutting line transverse to the transport direction, wherein the cutter comprises a blade extending in a blade plane, wherein the blade plane extends at a blade angle with respect to the conveyor plane about a blade axis parallel to the conveyor plane and transverse to the transport direction, wherein the blade is movable with respect to the conveyor plane in a cutting direction in a cutting plane, wherein the cutting plane extends at an oblique cutting angle with respect to the conveyor plane about an axis parallel to the conveyor plane and transverse to the transport direction, and wherein the cutting angle is smaller than the blade angle.

In other words, the cutting direction has a vector component in the transport direction relative to the blade plane. Hence, the blade can cut the tire component at a sharper angle than the blade angle. Accordingly, the resulting leading and trailing ends of the cut to length tire component can have sharper angles. Hence a splice between said leading and trailing ends can be improved. Additionally, due to the difference between the cutting angle and the blade angle, the blade is moved away from the leading end of the tire component during cutting. Hence, friction between said leading end and the second bevel face of the blade can be reduced, diminished or, ultimately, prevented. Hence, a required actuation force of the cutter can be reduced.

In an embodiment thereof, the blade comprises a first bevel face facing away from the conveyor plane, a second bevel face facing towards the conveyor plane, and a blade centerline between said first bevel face and said second bevel face, and wherein either the blade centerline, or the first bevel face, or the second bevel face extends in the blade plane. Together, the first bevel face and the second bevel face terminate in a cutting edge at the blade centerline. The blade plane can be defined by either the blade centerline, or the first bevel face, or the second bevel face.

In a further embodiment, the servicer further comprises a cutter bar downstream of the conveyor in the transport direction for supporting the tire component in a cutter bar plane and for cooperating with the cutter for cutting through the tire component along the cutting line at the cutter bar.

According to a second aspect, the invention relates to a servicer for supplying a tire component to a tire building drum or a transfer wheel, wherein the servicer comprises a conveyor for supporting the tire component at a first side of a conveyor plane and for transporting said tire component in a transport direction parallel to said conveyor plane, wherein the servicer further comprises a cutter bar downstream of the conveyor in the transport direction, wherein the cutter bar is provided with a support surface for supporting the tire component in a cutter bar plane and for cooperating with a cutter for cutting through the tire component at the cutter bar along a cutting line extending in said cutter bar plane in a direction transverse to the transport direction, wherein cutter bar plane extends at an oblique cutter bar angle to the conveyor plane about a cutter bar axis parallel to the conveyor plane and transverse to the transport direction.

In other words, the support surface is positionable at said oblique cutter bar angle to the conveyor plane about the cutter bar axis. Hence, a cutting angle between the cutter and the cutter bar can be set or adapted independent of a clearance between said cutter and the conveyor. In particular, the cutting angle at which the tire component is cut can be decreased without decreasing the clearance between the cutter and the conveyor. Hence, the leading and trailing ends of the tire component can be cut at a sharper angle, which can facilitate the splicing of said leading and trailing ends and/or can ultimately improve the quality of the splice between said leading and trailing end. Thus, the overall quality of the resulting tire can be improved.

In an embodiment thereof, the support surface is arranged to extend away from the conveyor plane at a second side of the conveyor plane opposite to the first side considered in the transport direction. In other words, the cutting angle between the cutter and the cutter bar is smaller than a clearance angle between the cutter and the conveyor. Hence, a sharper cutting angle can be obtained as compared to a cutter bar in line with the conveyor plane.

In a further embodiment, the cutter bar angle is between zero and forty-five degrees, preferably between five and forty degrees, more preferably between ten and thirty degrees. Said cutter bar angles can effect a smooth or substantially smooth transition for the tire component to be transported from the conveyor to the cutter bar. Additionally, said cutter bar angles can affect a sufficiently sharp cutting angle at which the tire component is cut.

In a further embodiment, the cutter bar is pivotable about the cutter bar axis to adjust the cutter bar angle. Hence, a cutting angle can be adjusted by adjusting the cutter bar angle only, i.e. without adjusting the clearance angle between the cutter and the conveyor. Thus the angle of the cutter relative to the conveyor can be fixed. The cutter bar angle can be easier to manipulate than the clearance angle of the cutter with respect to the conveyor. In other words, adjusting the cutting angle at which the tire component is cut can be facilitated.

In an embodiment thereof, the conveyor comprises a head pulley at a terminal end thereof downstream in the transport direction, wherein said head pulley is rotatable about a rotation axis transverse or perpendicular to the transport direction, and wherein the cutter bar axis corresponds to said rotation axis. Said head pulley may for example be a sprocket of a belt conveyor or a roll of a roller conveyor. The cutter bar can conveniently be rotatably mounted to the rotation axis of said head pulley.

In a further embodiment, the servicer comprises the cutter. In other words, the cutter is integrated into the servicer. Thus, an orientation between the conveyor and the cutter van be prefixed. Accordingly, the cutting angle can be adjusted by adjusting the cutter bar angle.

In an embodiment thereof, the cutter comprises a blade extending in a blade plane, wherein the blade plane extends at an oblique blade angle with respect to the cutter bar plane about a blade axis parallel to the conveyor plane and transverse to the transport direction.

In an embodiment thereof, the blade comprises a first bevel face facing away from the cutter bar plane, a second bevel face facing towards the cutter bar plane, wherein the first bevel face and the second bevel face terminate in a cutting edge, and wherein the blade plane extends through the cutting edge between the first bevel face and the second bevel face and/or along said first bevel face or said second bevel face. Preferably, the blade plane extends along the center line of the blade.

In a further embodiment, the blade is movable with respect to the conveyor plane in a cutting direction in a cutting plane, wherein the cutting plane extends at an oblique cutting angle with respect to the cutter bar plane about an axis parallel to the conveyor plane and transverse to the transport direction. Preferably, the cutting direction extends perpendicular to the cutting line. In other words, the cutter is a guillotine type knife. The cutting angle can cause the leading and trailing ends of the tire component to be cut at an oblique angle.

In an embodiment thereof, the cutting angle is smaller than the blade angle. In other words, the cutting direction has a vector component in the transport direction relative to the blade plane. Hence, the blade can cut the tire component at a sharper angle than the blade angle. Accordingly, the resulting leading and trailing ends of the cut to length tire component can have sharper angles. Hence a splice between said leading and trailing ends can be improved. Additionally, due to the difference between the cutting angle and the blade angle, the blade is moved away from the leading end of the tire component during cutting. Hence, friction between said leading end and the second bevel face of the blade can be reduced, diminished or, ultimately, prevented. Hence, a required actuation force of the cutter can be reduced.

Alternatively, the cutting angle and the blade angle may be equal.

In a further embodiment, the servicer further comprises a clamping element for clamping the tire component to the conveyor. The clamping element can for example be a clamping bar or a clamping roller for clamping the tire component over the entire width thereof. The clamping element can clamp the tire component during the cutting thereof. Hence, movements of the tire component with respect to the cutting line can be reduced or ultimately prevented. Thus, the tire component can be cut more accurately and/or precisely.

In a preferred embodiment thereof, the clamping element is movable along a clamping trajectory between a clearance position, spaced apart from the conveyor plane at the first side of said conveyor plane, and a clamping position, closer to the conveyor plane than the clearance position, for clamping the tire component on the conveyor at or near the cutting line. Preferably, the clamping trajectory comprises a circular arc. Alternatively, the clamping trajectory may be linear.

In a further embodiment, the blade is movable with respect to the conveyor plane between an idle position, at a distance of the conveyor plane at the first side of said conveyor plane, and a cutting position, for cutting the tire component, in the cutting direction along a cutting trajectory in the cutting plane, and wherein the cutting trajectory and the clamping trajectory intersect. In other words, when the clamping element is in the clearance position thereof, said clamping element is not arranged within the clearance space between the blade and the conveyor. Hence, the clamping trajectory is not limited by said clearance space. In particular, the clamping trajectory is not limited by said clearance space near the cutting line. Hence, the clamping element can clamp the tire component closer to the cutting line. Thus, the position of the tire component near the cutting line can be more accurately controlled. Hence, the tire component can be cut more accurately.

In an embodiment thereof, the blade is movable between the idle position and the cutting position along the cutting trajectory when said clamping element is in the clearance position. In other words, when the clamping element is in the clearance position, said clamping element can allow a movement of the blade along the cutting trajectory. Hence, the tire component can be cut while clamping said tire component near the cutting line.

In an embodiment thereof, the clamping element is, in the clearance position, located downstream of the cutting plane in the transport direction. In other words, in said clearance position, the clamping element is located at an opposite side of the cutting plane with respect to the conveyor. Hence, in the clearance position, the clamping element does not need to be accommodated in the clearance space between the blade and the conveyor. Accordingly, said clearance space can be reduced, i.e. the angle of the blade with respect to the conveyor can be reduced. Hence, the tire component can be cut at a sharper angle. Accordingly, the leading and trailing edges of the cut to length tire component can have sharper angles. Thus, the quality of the splice between said leading and trailing ends can be improved.

In a further embodiment, the blade is movable between the idle position and the cutting position along the cutting trajectory when said clamping element is in the clamping position.

In a further embodiment, the clamping element, in the clamping position, is located upstream of the cutting plane in the transport direction. In other words, in said clamping position, the clamping element is located at the same side of the cutting plane as the conveyor. Thus, the clamping element can clamp the tire component upstream of the cutting line in the transport direction.

In a further embodiment, the clamping element is movable from the clearance position to the clamping position along the clamping trajectory when said blade is in the idle position. In other words, when in the idle position, the blade allows the movement of the clamping element from the clearance position towards the clamping position and vice versa.

In an embodiment, the servicer further comprises an applicator roller extending in an axial direction for pressing the tire component on the tire building drum or the transfer wheel in a pressing direction transverse or perpendicular to the axial direction. Preferably, the applicator roller comprises a roller beam extending in the axial direction, wherein the applicator roller further comprises a plurality of independently rotatable roller disks arranged side-by-side or juxtaposed in the axial direction, wherein the roller disks each comprise a disk aperture extending through the respective roller disk in the axial direction to accommodate the roller beam, and wherein the disk aperture allows a movement of the roller disk with respect to the roller beam in the pressing direction, wherein the applicator roller further comprises a blocking member which is insertable into one or more of the roller apertures of one or more roller disks, respectively, to block the movement of said roller disks in the pressing direction. The blocking member can selectively block a movement of a respective roller disk. Hence, the width of the actuated part of the roller disk can be adjusted.

According to a third aspect, the invention provides a servicer for supplying a tire component to a tire building drum or a transfer wheel, wherein the servicer comprises a conveyor for supporting the tire component at a first side of a conveyor plane and for transporting said tire component in a transport direction parallel to said conveyor plane, wherein the servicer further comprises a cutter for cutting through the tire component along a cutting line transverse to the transport direction, wherein the cutter comprises a blade extending in a blade plane extending at an oblique blade angle with respect to the conveyor plane about an axis parallel to said conveyor plane and transverse to the transport direction, wherein the blade is movable with respect to the conveyor plane between an idle position, at a distance of the conveyor plane at the first side of said conveyor plane, and a cutting position, for cutting the tire component, in a cutting direction along a cutting trajectory in a cutting plane extending at a cutting angle with respect to the conveyor about an axis parallel to the conveyor plane and transverse to the transport direction, wherein the servicer further comprises a clamping element which is movable along a clamping trajectory between a clearance position, at a distance of the conveyor plane at the first side of said conveyor plane, and a clamping position, closer to the conveyor plane than the clearance position, for clamping the tire component to the conveyor, and wherein the cutting trajectory and the clamping trajectory intersect.

In other words, when the clamping element is in the clearance position thereof, said clamping element is not arranged within the clearance space between the blade and the conveyor. Hence, the clamping trajectory is not limited by said clearance space. In particular, the clamping trajectory is not limited by said clearance space near the cutting line. Hence, the clamping element can clamp the tire component closer to the cutting line. Thus, the position of the tire component near the cutting line can be more accurately controlled. Hence, the tire component can be cut more accurately.

In an embodiment thereof, the clamping trajectory comprises a circular arc or the clamping trajectory is linear.

In a further embodiment, the blade is movable between the idle position and the cutting position along the cutting trajectory when said clamping element is in the clearance position.

In an embodiment thereof, the blade is movable between the idle position and the cutting position along the cutting trajectory when said clamping element is in the clearance position. In other words, when the clamping element is in the clearance position, said clamping element can allow a movement of the blade along the cutting trajectory. Hence, the tire component can be cut while clamping said tire component near the cutting line.

In an embodiment thereof, the clamping element is, in the clearance position, located downstream of the cutting plane in the transport direction. In other words, in said clearance position, the clamping element is located at an opposite side of the cutting plane with respect to the conveyor. Accordingly, said clearance space can be reduced, i.e. the angle of the blade with respect to the conveyor can be reduced. Hence, the tire component can be cut at a sharper angle. Accordingly, the leading and trailing edges of the cut to length tire component can have sharper angles. Thus, the quality of the splice between said leading and trailing ends can be improved.

In a further embodiment, the blade is movable between the idle position and the cutting position along the cutting trajectory when said clamping element is in the clamping position.

In a further embodiment, the clamping element, in the clamping position, is located upstream of the cutting plane in the transport direction. In other words, in said clamping position, the clamping element is located at the same side of the cutting plane as the conveyor. Thus, the clamping element can clamp the tire component upstream of the cutting line in the transport direction.

In a further embodiment, the clamping element is movable from the clearance position to the clamping position along the clamping trajectory when said blade is in the idle position. In other words, when in the idle position, the blade allows the movement of the clamping element from the clearance position towards the clamping position and vice versa.

According to a fourth aspect, the invention provides a method for cutting through a tire component supported in support plane using a blade extending in a blade plane, wherein the blade plane extends at a blade angle with respect to the support plane about a blade axis parallel to the support plane, wherein the method comprises the step of:
moving the blade with respect to the support plane in a cutting direction in a cutting plane extending at a cutting angle with respect to the support plane about an axis parallel to the support plane, and wherein the cutting angle is smaller than the blade angle.

In other words, the blade is moved with a vector component in the transport direction relative to the blade plane. Hence, the blade can cut the tire component at a sharper angle than the blade angle. Accordingly, the resulting leading and trailing ends of the cut to length tire component can have sharper angles. Hence a splice between said leading and trailing ends can be improved. Additionally, due to the difference between the cutting angle and the blade angle, the blade is moved away from the leading end of the tire component during cutting. Hence, friction between said leading end and the second bevel face of the blade can be reduced, diminished or, ultimately, prevented. Hence, a required actuation force of the cutter can be reduced.

According to a fifth aspect, the invention provides a method for supplying a tire component to a tire building drum or a transfer wheel using the servicer according to the first aspect of the invention, wherein the method comprises the steps of:
a) conveying the tire component in the transport direction past the cutting line;
b) cutting through the tire component at the cutting line; and
c) supplying the cut tire component to the tire building drum or the transfer wheel.

The method incorporates the servicer according to the first aspect of the present invention and, hence, has the same advantages as discussed above.

In an embodiment thereof, step b) comprises moving the blade with respect to the conveyor plane in the cutting direction, wherein the cutting angle is smaller than the blade angle. This embodiment incorporates the method according to the eighth aspect of the invention. Hence, the advantages correspond.

According to a sixth aspect, the invention provides a method for supplying a tire component to a tire building drum or a transfer wheel using the servicer according to the second aspect of the invention, wherein the method comprises the steps of:
a) conveying the tire component in the transport direction past the cutting line;
b) cutting through the tire component at the cutting line; and
c) supplying the tire cut component to the tire building drum or the transfer wheel.

The method incorporates the servicer according to the second aspect of the present invention and, hence, has the same advantages as discussed above.

In an embodiment thereof, the method further comprises the step of adjusting the cutter bar angle. By adjusting the cutter bar angle, the cutting angle of the leading and trailing ends of the tire component can be adjusted without changing the angle of the cutter with respect to the conveyor.

Preferably, the cutter bar angle is adjusted within a range between zero and forty-five degrees with respect to the conveyor plane, preferably between five and forty degrees, more preferably between ten and thirty degrees.

According to a seventh aspect, the invention provides a method for supplying a tire component to a tire building drum or the transfer wheel using the servicer according to the third aspect of the invention, wherein the method comprises the steps of:
a) conveying the tire component in the transport direction past the cutting line;
b) cutting through the tire component at the cutting line; and
c) supplying the cut tire component to the tire building drum or the transfer wheel.

The method incorporates the servicer according to the third aspect of the present invention and, hence, has the same advantages as discussed above.

In an embodiment thereof, step b) comprises:
moving the clamping element with respect to the conveyor plane along a clamping trajectory from a clearance position, spaced apart from the conveyor plane at the first side of said conveyor plane, towards a clamping position, closer to the conveyor plane than the clearance position, for clamping the tire component on the conveyor at or near the cutting line while the blade is in an idle position, at a distance of the conveyor plane at the first side of said conveyor plane; and
moving the blade with respect to the conveyor plane from the idle position in the cutting direction along a cutting trajectory in the cutting plane towards a cutting position for cutting the tire component, wherein the cutting trajectory intersects the clamping trajectory. By clamping the tire component at or near the cutting line, said tire component can be cut more accurately.

In a further embodiment thereof, step b) subsequently comprises:
moving the blade with respect to the conveyor plane from the cutting position towards the idle position along the cutting trajectory; and
moving the clamping element with respect to the conveyor plane from the clamping position towards the clearance position along the clamping trajectory.

According to an eighth aspect, the invention provides an assembly comprising the servicer according to the first aspect, the second aspect or the third aspect of the invention and a tire building drum or a transfer wheel, wherein the cutter bar is arranged between the conveyor and the tire building drum or between the conveyor and the transfer wheel.

The tire component can thus be directly transferred from the cutter bar to the circumferential surface of either the tire building drum or the transfer wheel.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIGS. 1-3 show an exemplary embodiment of a servicer according to the present invention during exemplary steps of supplying a tire component to a tire building drum;

FIGS. 4-6 show a detailed view of the servicer of FIG. 3 during further exemplary steps of supplying the tire component to a tire building drum; and

FIG. 7 shows an isometric view of the servicer according to FIG. 1.

### DETAILED DESCRIPTION OF THE INVENTION

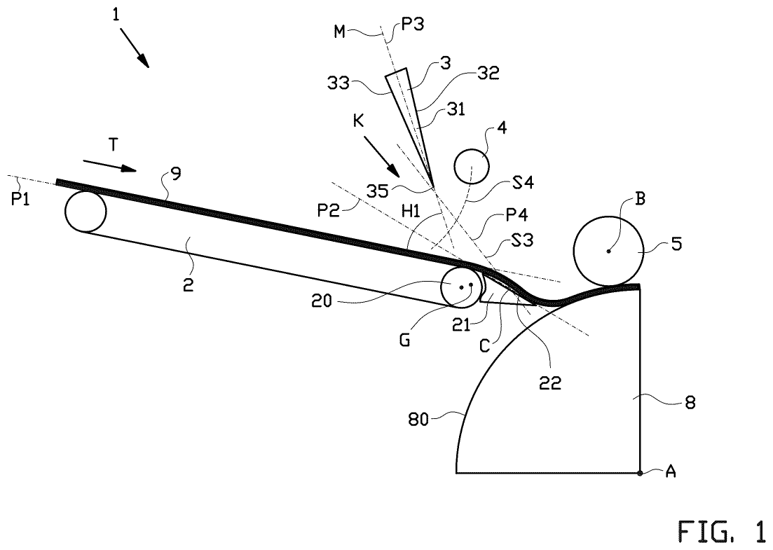

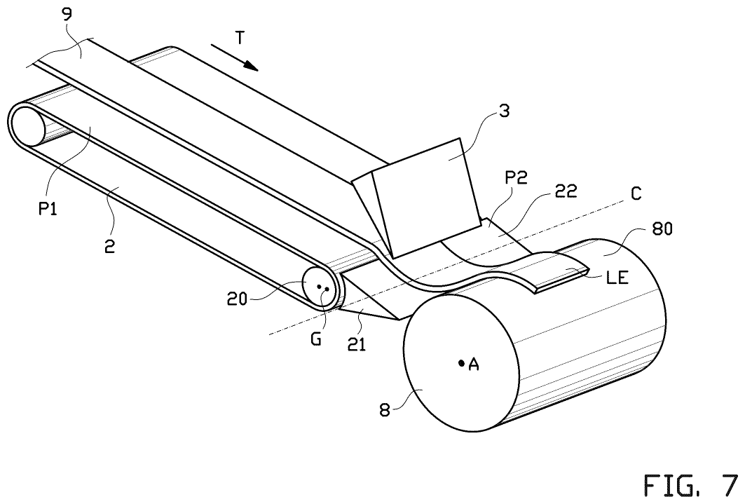

FIGS. 1-6 and 7 show an servicer 1 for supplying a tire component 9 to a tire building drum 8 according to the present invention. In this particular embodiment, the servicer is arranged for supplying the tire component 9 directly to the tire building drum 8. Alternatively, the servicer 1 may be arranged for supplying the tire component 9 to a transfer drum or transfer wheel. Said transfer wheel or transfer drum is arranged for subsequently supplying the tire component 9 to the tire building drum 8.

The servicer 1 comprises a conveyor 2 for conveying the tire component in a transport direction T towards the tire building drum 8. The servicer 1 further comprises a cutter 3 for cutting the tire component 9 to length along a cutting line C transverse or perpendicular to the transport direction T and a cutter bar 21 for cooperating with the cutter 3. Alternatively, a separate cutter may be provided for cutting the tire component 9 to length.

The building drum 8 is rotatable about a drum axis A to apply the tire component around the perimeter thereof. The building drum 8 comprises a circumferential surface 80 or circumferential support surface for receiving the tire component 9. Said circumferential surface 80 extends circumferentially about the drum axis A.

The conveyor 2 is arranged to support the tire component 9 at a first side of a conveyor plane P1 or support plane. The transport direction T extends parallel to said conveyor plane P1. The transport direction T extends in or substantially in a radial plane extending perpendicular to or radially with respect to the drum axis A. The conveyor 4 may for example be a belt conveyor or a roller conveyor.

The cutter bar 21 is arranged downstream of the conveyor 2 in the transport direction T. As can be seen in the figures, the conveyor comprises a head pulley 20, sprocket or roller at a the terminal end thereof in the transport direction T. Preferably, the cutter bar 21 is arranged adjacent to or neighboring said head pulley 20. The cutter bar 21 comprises a support surface 22 for supporting the tire component 9 in a cutter bar plane P2. Said support surface 22 may for example form an anvil or striking surface for the cutter 3.

The cutter bar plane P2 extends at an oblique cutter bar angle H2 with respect to the conveyor plane P1 about a cutter bar axis G. In particular, the support surface 22 extends away from the conveyor plane at a second side of the conveyor plane P1 opposite to the first side. The cutter bar axis G extends parallel to the conveyor plane P2. The cutter bar axis G extends transverse or perpendicular to the transport direction T.

Preferably, the cutter bar angle H2 is within the range of zero to forty-five degrees. More preferably, the cutter bar angle H2 is within the range of five and forty degrees. Most preferably the cutter bar angle H2 is within the range of ten and thirty degrees.

The cutter bar 21 may be arranged at a fixed cutter bar angle H2 with respect to the conveyor plane P1. Alternatively, the cutter bar 21 may be pivotable about the cutter bar axis G to adjust the cutter bar angle H2. Said cutter bar axis G may for example correspond to the rotation axis of the head pulley 20. Preferably, the cutter bar 21 is pivotable with respect the conveyor plane P1 within the abovementioned preferred range.

As is further shown in FIGS. 1-6, the cutter 3 comprises a blade 31 or knife for cutting through the tire component 9. The blade 31 comprises a first bevel face 32 facing away from the cutter bar plane P2 and a second bevel face 33 facing towards the cutter bar plane P2. The first bevel face 32 and the second bevel face 33 terminate in a cutting edge 35. The blade 31 further comprises a blade centerline M. Said blade center line M extends through the cutting edge 35 between said first bevel face 32 and said second bevel face 33.

As is further shown in FIGS. 1-6, the blade 31 extends in a blade plane P3. The blade plane P3 extends through the cutting edge 35 between the first bevel face 32 and the second bevel face 33. In the embodiment as shown, the blade center line M extends in the blade plane P3. In other words, the blade plane P3 is defined by the blade center line M. Alternatively, the blade plane P3 may for example be defined by either the first bevel face 32 or the second bevel face 33 of the blade 31. The blade plane P3 extends at an oblique blade angle H3 with respect to the cutter bar plane P2 about a blade axis. Preferably, said blade axis extends parallel to the conveyor plane P1 and transverse or perpendicular to the transport direction T.

The blade 31 extends at a clearance angle H1 with respect to the conveyor plane P1. Said clearance angle H1 is equal to the sum of the blade angle H3 and the cutter bar angle H2. Said clearance angle H1 defines a clearance space extending between the blade 31 and the conveyor 2.

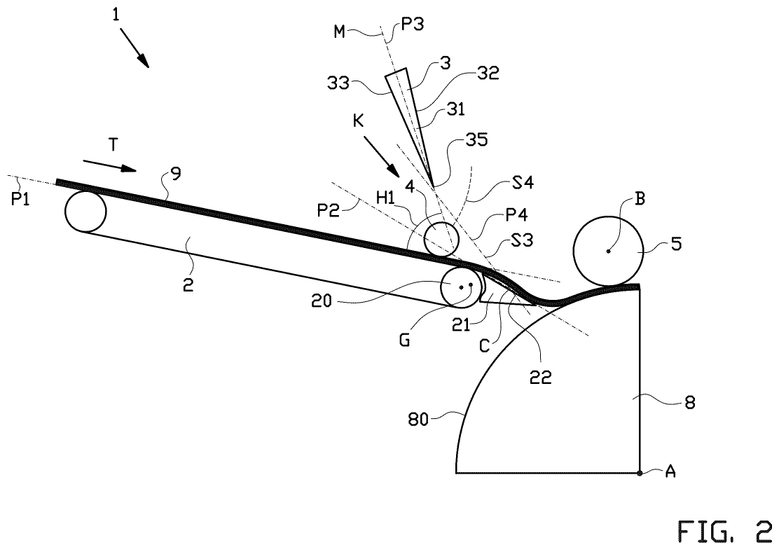

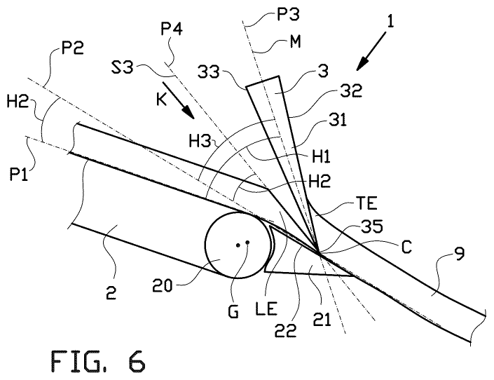

The blade 31 is movable with respect to the conveyor plane P1 and/or the support plane P2 in a cutting direction K. In particular, the blade 31 is movable in the cutting direction K along a cutting trajectory S3 between an idle position, as shown in FIGS. 1 and 2, and a cutting position, as is shown in FIG. 6. In said idle position, the blade 31 is arranged at a distance of the conveyor plane P1 and/or the support plane P2 at the first side of the conveyor plane P1. In the cutting position, the blade 31 is arranged for cutting through the tire component 9. In particular, in said cutting position, the cutting edge 35 of the blade 31 is arranged at or near the cutting line C.

The cutting trajectory S3 extends in a cutting plane P4. Said cutting plane P4 extends at an oblique cutting angle H4 with respect to the conveyor plane P1 and/or the cutter bar plane P2 about an axis parallel to the conveyor plane P1 and transverse or perpendicular to the transport direction T.

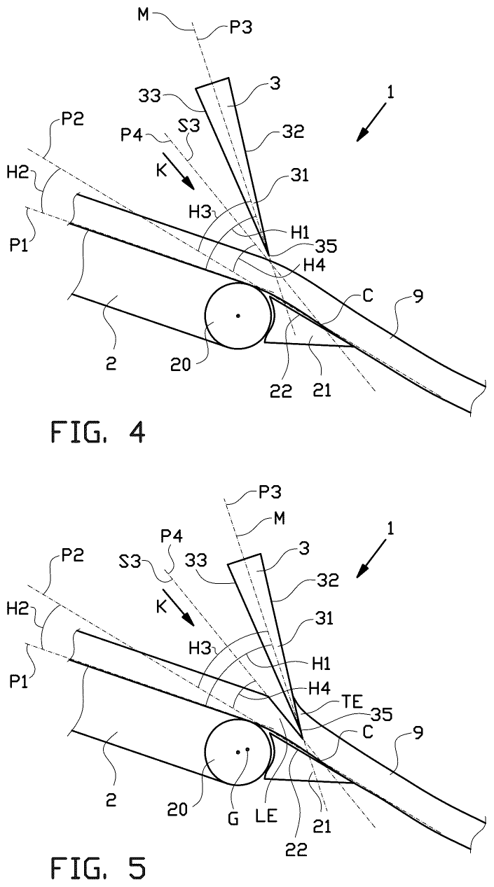

As is best shown in FIGS. 4-6, in this particular embodiment, the cutting angle H3 is smaller than the blade angle H4. In other words, the blade plane P3 is displaced in the transport direction T relative to the cutter plane P4 when the blade 31 is moved in the cutting direction K. Hence, the cutting line C is defined by the intersection of the cutting plane P4 and the cutter bar plane P2. Alternatively, the cutting angle H3 may be the same as the blade angle H4.

As is shown in FIGS. 1-3, the servicer further comprises a clamping element 4 for clamping the tire component 9 to the conveyor 2 or the cutter bar 21. In particular, the clamping element 4 is arranged for clamping the tire component 9 to the conveyor 2 at or near the cutting line C, preferably downstream of said cutting line C in the transport direction T. Said clamping element 4 may for example be a clamping bar or a clamping roller.

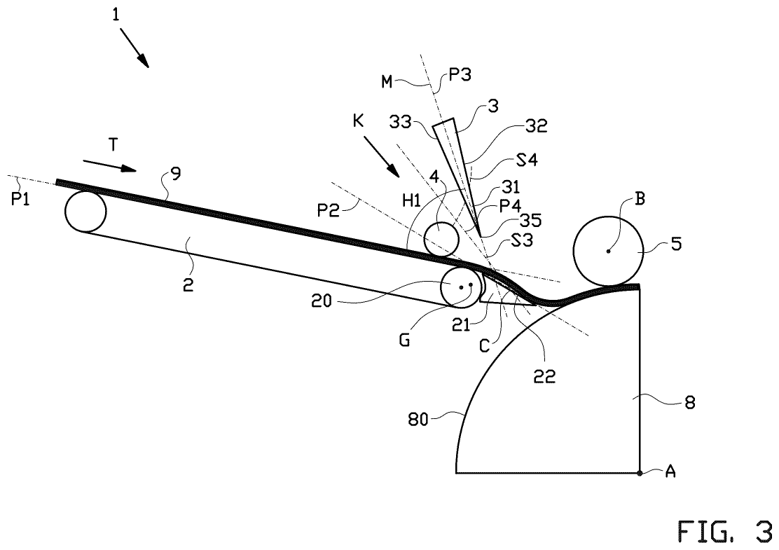

The clamping element 4 is movable along a clamping trajectory S4. In particular, the clamping element 4 is movable along the clamping trajectory between a clearance position, as is shown in FIG. 1, and a clamping position as is shown in FIGS. 2 and 3, for clamping the tire component 9 on the conveyor 2 or the cutter bar 21.

In said clearance position, the clamping element 4 is spaced apart from the conveyor plane P1 at the first side of said conveyor plane P1. In the clamping position, the clamping element 4 is arranged closer to the conveyor plane P1 than in the clearance position.

In the embodiment as shown, the clamping trajectory S4 comprise a circular arc. Said clamping trajectory S4 may for example be affected by pivoting the clamping element 4 about a pivot axis located upstream of the cutting line C in the transport direction T. In particular, the clamping element 4 may be mounted to one or more arms (not shown) that are pivotable about said pivot axis. Alternatively, the clamping element 4 may be linearly movable along a linear clamping trajectory (not shown). This may for example be affected by a linear drive, such as a pneumatic cylinder.

As can further be seen in FIGS. 1-3, the cutting trajectory S3 and the clamping trajectory S4 intersect. In particular, when in the clearance position, the clamping element 4 is located downstream of the cutting plane P4 in the transport direction T. In other words, in said clearance position, the clamping element 4 is located on the opposite side of the cutting plane P4 with respect to the conveyor 2. Hence, in the clearance position, the clamping element 4 is located outside of the clearance space defined by the clearance angle H1.

When in the clamping position, the clamping element 4 is located upstream of the cutting plane P4 in the transport direction T. In other words, the clamping element 4 is located at the same side of the cutting plane P4 as the conveyor 2. Hence, in the clamping position, the clamping element 4 is located within the clearance space defined by the clearance angle H1.

As is best shown in FIGS. 2 and 3, the clamping element 4 allows a movement of the blade 31 along the cutting trajectory S3 when said clamping element 4 is in the clamping position. In other words, the blade 31 is movable along the cutting trajectory S3 when said clamping element 4 is in the clamping position. Accordingly, as is shown in FIG. 1, the clamping element 4 is movable along the clamping trajectory S4 when the blade 31 is in the idle position. As is further shown in FIG. 1, the blade 31 is movable along the cutting trajectory S3 when the clamping element 4 is in the clearance position as well.

As is further shown in FIGS. 1-3, the servicer 1 further comprises an applicator roller 5 for applying the tire component 9 to the tire building drum 8 or to a further tire component (not shown) that has already been applied to said building drum 8. In particular, the applicator roller 5 is arranged for pressing the tire component 9 on the circumferential surface 80 of the tire building drum 8 in a pressing direction Y. Preferably, said pressing direction corresponds to or substantially corresponds to a radial direction of the tire building drum 8 perpendicular to the drum axis A.

In this particular embodiment, the applicator roller 5 is a multi-disk roller. Multi-disks rollers are known per se, and are for example disclosed in WO2019/182439A1 of the applicant.

A method for supplying a tire component 9 to a tire building drum 8, using the servicer 1 according to the present invention, will now be elucidated using FIGS. 1-6.

As is shown in FIG. 1, a tire component 9 has been conveyed in the transport direction T by the conveyor 2. The tire component 9 has been conveyed in the transport direction T over the cutter bar 21, i.e. past the cutting line C and onto the tire building drum 8. A leading end of said tire component 9 (not shown) has been applied to the circumferential surface 80 of the tire building drum 8. The tire component 9 has been wound about at least a part of said circumferential surface 80 by rotating the tire building drum 8 about the drum axis A. In particular, when regarding FIG. 1, the tire building drum 8 has been rotated clockwise about the drum axis A. Optionally, the tire component 9 has been pressed onto the circumferential surface 80 by the applicator roller 5.

The cutter bar 21 has been positioned at the cutter bar angle H2. Optionally, the cutter bar angle H2 may be adjusted to alter an angle of the respective leading end LE and trailing end TE of the tire component 9 when said tire component 9 is cut to length. Preferably, the cutter bar angle H2 is positioned and/or adjusted within the previously specified range.

As can further be seen in FIG. 1, the blade 31 is in the idle position thereof and the clamping element 4 is in the clearance position to allow the tire component 9 to be conveyed passed the cutting line C in the transport direction T.

As is shown in FIG. 2, the clamping element 4 has been moved along the clamping trajectory S4 into the clamping position for clamping the tire component 9 near the cutting line C. The blade 31 is still in the idle position to allow said movement of the clamping element 4 along the clamping trajectory S4. Preferably, the conveyor 2 and the tire building drum 8 have been stopped to cease the conveying of the tire component 9 in the transport direction T.

As is shown in FIG. 3, the blade 31 has been moved in the cutting direction K along the cutting trajectory S3 towards the cutting position. The tip of the blade 31, i.e. the cutting edge 35, has crossed the clamping trajectory S4.

As is shown in FIGS. 4-6, the blade 31 is now moved further along the cutting trajectory S3 to cut into the tire component 9 along the cutting line C. By cutting the tire component 9 an oblique trailing end TE is formed at the cut of part of the tire component 9 downstream of the cutting line C in the transport direction T. Accordingly, an oblique leading end LE is formed at the part of the tire component 9 upstream of the cutting line C in the transport direction T. The resulting leading end LE and trailing end TE are cut at the oblique cutting angle H4.

As is best shown in FIGS. 5 and 6, the cutting edge 35 of the blade 31 is moved along the cutting line C in the cutting plane P4. In the embodiment as shown, the cutting angle H4 at which the tire component 9 is cut is smaller than the blade angle 31. Hence, when moving the blade 31 in the cutting direction K, the first bevel face 32 urges the trailing end TE away from the cutting plane P4. Accordingly, the second bevel face 33 of the blade 31 is moved away from the cutting plane P4 as well. Hence, the second bevel face 33 may at least partly detach from the leading end LE.

After the tire component 9 has been cut to length along the cutting line C, the trailing end TE of said cut to length tire component 9 is applied around the circumferential surface 80 of the tire building drum 8. Optionally, the tire component 9 is pressed onto the circumferential surface 80, or onto a further tire component (not shown) that has already been applied to said circumferential surface 80, using the applicator roller 5.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

In summary, the invention relates to an servicer for supplying a tire component to a tire building drum or a transfer wheel, wherein the servicer comprises a conveyor for supporting the tire component at a first side of a conveyor plane and for transporting said tire component in a transport direction parallel to said conveyor plane, wherein the servicer further comprises a cutter bar downstream of the conveyor in the transport direction, wherein the cutter bar is provided with a support surface for supporting the tire component in a cutter bar plane and for cooperating with a cutter for cutting through the tire component at the cutter bar along a cutting line transverse to the transport direction, wherein the cutter bar plane extends at an oblique cutter bar angle to the conveyor plane about a cutter bar axis parallel to the conveyor plane and transverse to the transport direction.

1-43. (canceled)

44. A servicer for supplying a tire component to a tire building drum or a transfer wheel,
wherein the servicer comprises a conveyor for supporting the tire component at a first side of a conveyor plane and for transporting said tire component in a transport direction parallel to said conveyor plane,
wherein the servicer further comprises a cutter for cutting through the tire component along a cutting line transverse to the transport direction,
wherein the cutter comprises a blade extending at an oblique clearance angle with respect to the conveyor plane about an axis parallel to said conveyor plane and transverse to the transport direction,
wherein the blade is movable with respect to the conveyor plane between an idle position, at a distance of the conveyor plane at the first side of said conveyor plane, and a cutting position, for cutting the tire component, in a cutting direction along a cutting trajectory in a cutting plane extending at a cutting angle with respect to the conveyor about an axis parallel to the conveyor plane and transverse to the transport direction,
wherein the servicer further comprises a clamping element which is movable along a clamping trajectory between a clearance position, at a distance of the conveyor plane at the first side of said conveyor plane, and a clamping position, closer to the conveyor plane than the clearance position, for clamping the tire component to the conveyor,
wherein the cutting trajectory and the clamping trajectory intersect,
wherein the clearance angle defines a clearance space extending between the blade and the conveyor, and wherein, in the clamping position, the clamping element is located within said clearance space.

45. The servicer according to claim 44, wherein the clamping trajectory comprises a circular arc.

46. The servicer according to claim 44, wherein the clamping trajectory is linear.

47. The servicer according to claim 44, wherein the blade is movable between the idle position and the cutting position along the cutting trajectory when said clamping element is in the clearance position.

48. The servicer according to claim 47, wherein the clamping element, in the clearance position, is located downstream of the cutting plane in the transport direction.

49. The servicer according to claim 44, wherein the blade is movable between the idle position and the cutting position along the cutting trajectory, when said clamping element is in the clamping position.

50. The servicer according to claim 49, wherein the clamping element, in the clamping position, is located upstream of the cutting plane in the transport direction.

51. The servicer according to claim 44, wherein the clamping element is movable from the clearance position to the clamping position along the clamping trajectory, when said blade is in the idle position.

52. A method for supplying a tire component to a tire building drum or a transfer wheel using the servicer according to claim 44, wherein the method comprises the steps of:
a) conveying the tire component in the transport direction past the cutting line;
b) cutting through the tire component at the cutting line; and
c) supplying the cut tire component to the tire building drum or the transfer wheel.

53. The method according to claim 52, wherein step b) comprises:
moving the clamping element with respect to the conveyor plane along a clamping trajectory from a clearance position, spaced apart from the conveyor plane at the first side of said conveyor plane, towards a clamping position, closer to the conveyor plane than the clearance position, for clamping the tire component on the conveyor at or near the cutting line while the blade is in an idle position, at a distance of the conveyor plane at the first side of said conveyor plane; and
moving the blade with respect to the conveyor plane from the idle position in the cutting direction along a cutting trajectory in the cutting plane towards a cutting position for cutting the tire component, wherein the cutting trajectory intersects the clamping trajectory.

54. The method according to claim 53, wherein step b) subsequently comprises:
moving the blade with respect to the conveyor plane from the cutting position towards the idle position along the cutting trajectory; and
moving the clamping element with respect to the conveyor plane from the clamping position towards the clearance position along the clamping trajectory.

55. An assembly comprising the servicer according to claim 44 and a tire building drum or a transfer wheel,
wherein the cutter bar is arranged between the conveyor and the tire building drum or between the conveyor and the transfer wheel.
